(19) United States
(12) Patent Application Publication
(10) Pub. No.: US 2009/0267426 A1
(43) Pub. Date: Oct. 29, 2009

(54) Liquid-cooled electric machine and method for cooling such electric machine

(76) Inventors: Klaus Graner, Uttenweiler-Ahlen (DE); Johann Lis, Riedlingen (DE)

Correspondence Address: JACOBSON HOLMAN PLLC, 400 SEVENTH STREET N.W., SUITE 600, WASHINGTON, DC, 20004, US

(21) Appl. No.: 12/385,488

(22) Filed: Apr. 9, 2009

(30) Foreign Application Priority Data
Apr. 9, 2006 (DE) 10 2008 018 064.5
May 5, 2006 (DE) 10 2008 022 105.8

(51) Int. Cl. H02K 9/19

(52) U.S. Cl. 310/54

(57) ABSTRACT

The present invention relates to an electric machine with a machine housing, in which a rotor and a stator winding are accommodated, wherein the stator winding includes winding heads arranged on opposite sides each in a winding head space, and with a cooling device which includes a liquid cooling circuit with a stator jacket cooling and cooling coils as well as a fan connected with the rotor for circulating air in the machine housing. The invention furthermore relates to a method for cooling such electric machine. In accordance with the invention it is provided that the cooling coils extend through the winding head spaces outside the winding heads and the fan includes two fan wheels each associated to a winding head space for generating an air flow circulating inside each winding head space, which by means of air duct and/or guiding means in the respective winding head space is circulatingly passed over the exposed cooling coils and through the winding heads. By cooling down the circulating internal air directly in or at the winding head space, a highly efficient cooling of the winding head space can be achieved, without having to sacrifice a compact construction.

The present invention relates to an electric machine with a machine housing in which a rotor and a stator winding are accommodated, wherein the stator winding includes winding heads arranged on opposite sides each in a winding head space, and with a cooling device which includes a liquid cooling circuit with a stator jacket cooling, cooling coils and a fan connected with the rotor for circulating air in the machine housing. The invention furthermore relates to a method for cooling such electric machine.

Certain types of electric machines generally are cooled by surface cooling or open-circuit cooling with forced ventilation or self-ventilation. Machines of medium performance, which are installed in plants with small packaging space or are used in regions where the heated cooling air of the motor is undesired, and traction machines, which are installed with restricted space, require high-performance cooling systems. Various cooling variants are used.

Jacket cooling of the stator core either can be effected with a cooling liquid such as oil or water, or direct oil cooling of the stator winding can be employed with a separating cylinder for the rotor. Especially for the winding heads, an oil spray cooling can be provided. There are known configurations in which the cooling liquid is passed through a cylindrical liquid chamber or a coil, which is cast in the housing or incorporated in the stator pack. Furthermore, there are also known solutions, in which the cooling coil is cast in a plastic housing which not only encloses the stator pack, but also the winding heads.

The problem of jacket cooling consists in that the rotor and the winding heads virtually remain uncooled. The temperature of the inner cooling air is increased, whereby the performance of the machine is restricted.

One remedy as regards the heating of the winding heads is proposed in DE 31 35 223, which provides a special configuration of the winding head cooling. Here, annular tubes are directly embedded in the winding head between two layers. Similarly, GB 947652 provides to embed cooling tubes in the winding head and directly cast the same into the casting resin of the stator winding. In this way, the contact between cooling tube and winding is improved and a good transfer of heat is achieved. However, the cooling tube is made of plastic material, which in turn considerably restricts the conduction of heat. What remains problematic in these cooling tubes embedded in the winding head is the fact that the rotor itself more or less remains uncooled.

DE 18 13 190 furthermore describes an electric machine as mentioned above, which in addition to a cooling coil embedded in the stator jacket realizes a winding head cooling with an internal air flow. This internal air flow is generated by a fan seated on the motor shaft and is passed over the cooling coil embedded in the stator shell via clearances in the machine housing. To be able to pass the internal air flow over the stator cooling coils in this way and to effectively couple the same with the liquid cooling system, an additional jacket housing with air conducting passages is mounted around the electric machine, so that the machine housing becomes a two-shell housing, so to speak. However, this has an adverse effect on the diameter and the weight of the motor.

Proceeding therefrom, it is the object underlying the present invention to create an improved liquid-cooled electric machine as mentioned above and an improved method for cooling the same, which avoid the disadvantages of the prior art and develop the latter in an advantageous way. In particular, with an intensive cooling of the stator pack of an electric machine with liquid jacket cooling a high degree of rotor and winding head cooling should be achieved with a space-saving construction.

In accordance with the invention, this object is solved by an electric machine according to claim 1 and by a cooling method according to claim 16. Preferred aspects of the invention are subject-matter of the dependent claims.

Accordingly, it is proposed to directly couple the internal air flow to the liquid cooling in or at the winding head space and thereby cool the same, so that the cooling air need not be guided around the outside of the stator jacket cooling in an expensive way. For this purpose, the liquid cooling is guided into the winding space or directly guided towards the same. In accordance with the invention, it is provided that the cooling coils are guided through the winding head spaces outside the winding heads, and the fan includes two fan wheels each associated to a winding head space for generating an air flow circulating within each winding head space, which by means of air duct and/or guiding means in the respective winding space is guided to circulate over the exposed cooling coils and through the winding heads. By cooling down the circulating internal air directly in or at the winding head space, a highly efficient cooling of the winding head space can be achieved without having to sacrifice a compact construction. This can be achieved with a simple configuration and manufacture of the winding head at the same time, since the cooling coils need not be embedded in the winding head.

In principle, said cooling air duct and/or guiding means can be formed differently. In accordance with a development of the invention they are configured such that at the neck of the winding head, i.e. at the transition between winding head and stator core, the cooling air passes through the winding head and circulates around the winding head, wherein the air flow passing through the winding head flows through between the outside of the winding head and the housing, around the end face of the winding head to the inside of the winding head or vice versa around the winding head.

In particular, the air duct and/or guiding means can comprise preferably slot-shaped through holes in the winding head arranged at the neck of the winding head, which are distributed over the circumference of the winding head. These through holes in the winding head can be achieved by various means which keep apart or spread apart the coil strands at the neck of the winding head. For instance, sleeve-like spreading elements might be provided between the strand bundles emerging from the stator core. In accordance with a development of the invention, other separating means can also be provided in the form of loops or tapes, which bundle the coil strands and keep clear the desired slot-shaped through holes.

Alternatively or in addition to said through holes extending radially through the winding head, cooling air recesses axially extending through the winding head in longitudinal direction can also be provided. If the radial through holes described above are also provided, the same advantageously communicate with said axial cooling air recesses. In this way, an improved cooling can also be achieved in the front part of the winding head.

In accordance with a development of the invention, the air duct and/or guiding means for the cooling air define a plurality of flow paths annularly extending around the winding heads, which through said through holes each annularly extend around a respective segment of the winding head, in which a respective through hole is formed. Said flow paths each extend radially through a through hole, then axially between the winding head and the machine housing along the winding head, then radially around an end-face winding head portion and axially back on an inside of the winding head to the through hole, wherein the flow direction possibly can also be oriented the other way round.

In principle, the cooling coils can be arranged at a different point in the winding head, and advantageously they are positioned in a portion with a strong circulation of cooling air. In accordance with an advantageous embodiment of the invention, the cooling coils can be arranged on the end faces of the winding heads. In this way, a high transfer of heat from the cooling air into the cooling coils can be achieved with a compact construction.

In accordance with an advantageous development of the invention, the cooling coils, are provided with cooling ribs, which increase the heat transfer surface and thereby considerably improve the cooling capacity. In particular, the cooling coils can be provided with radially arranged axial ribs in the manner of extruded sections. Alternatively, transverse ribs or helical cooling, ribs can also be provided.

As regards the guidance of the cooling air, the machine basically can be provided in different configurations. In accordance with an advantageous development of the invention, the winding head spaces arranged on opposite sides each can form closed air circulation spaces, which are formed separate from each other in terms of air circulation, so that no cooling air is axially guided from one end face of the machine to the other end face, but on each end face of the machine a separate air circulation is effected in the respective winding head space. In this way, both a simple and a very compact construction can be achieved.

To achieve a stronger cooling of the rotor, the cooling air can also be guided into the rotor. For this purpose, it can in particular be provided that the winding head spaces as such form closed air circulation spaces, i.e. spaces which do not communicate with the surroundings of the machine, but are connected with each other via at least one air duct which axially extends through the rotor. Advantageously, four or more axial cooling air recesses can extend through the rotor, via which the two winding head spaces and the cooling air circulating therein can communicate with each other. By means of such cooling air recesses in the rotor, an improved cooling of the rotor can be achieved, wherein a configuration of the machine slender in diameter can be maintained, since a passage of air between the machine housing and the stator is not required. The machine housing can be seated on the stator without any clearance, which enables a construction slender in cross-section with a small diameter.

In accordance with an advantageous development of the invention, the cooling air is countercurrently guided through the rotor. The aforementioned air duct and/or guiding means advantageously comprise a counterflow means, which countercurrently passes the cooling air through the cooling air recesses in the rotor. While a first set of cooling air recesses guides the cooling air from a left-hand winding head space to a right-hand winding head space, a second set of cooling air recesses in the rotor serves to countercurrently guide the cooling air from the right-hand winding head space into the left-hand winding head space.

Countercurrently passing the cooling air through the rotor advantageously can be achieved by a particular formation and arrangement of the fan wheels. For this purpose, it can in particular be provided that the fan wheels are formed by attachment disks with blade-like air conveying means, which are directly seated on the rotor, and/or by correspondingly blade-like air conveying means molded to the rotor, wherein advantageously on each end face of the rotor a set of cooling air recesses communicates with an outside of the winding head and another set of cooling air recesses communicates with the inside of the winding head. Advantageously, a hole offset is provided on the two end faces, i.e. the cooling air recesses, which on the one rotor end face communicate with the outside of the winding head, communicate with the inside of the winding head on the other rotor end face, and vice versa.

In particular, it can be provided that the fan wheels in the form of the aforementioned attachment disks are accommodated in the interior of the winding head and on the one hand have radial discharge means, which are directed into the through holes in the winding head, and on the other hand have inlet passages which each are in flow connection with at least one cooling air duct in the rotor, wherein the attachment disks are rotatorily offset with respect to each other on opposite end faces of the rotor such that the inlet passages of the one attachment disk communicate with a first set of air ducts in the rotor, and the inlet passages of the other attachment disk communicate with a second set of air ducts in the rotor. In this way, the cooling air is countercurrently guided through the rotor, wherein each fan wheel radially forces the cooling air through the through holes in the winding head, so that the cooling air flows around the winding head and over the cooling coils into the interior of the winding head. Due to the excess pressure obtained there, the cooling air is guided through the axial cooling air recesses in the rotor, which communicate with the interior of the winding head via the inlet passages, to the other end face of the machine, where it correspondingly is guided around the winding head by the fan wheel preferably provided there in the form of the attachment disk and then is forced into the respectively other axial cooling air recesses in the rotor.

As an alternative to the above-described configuration with attachment disks seated on the rotor end faces, the fan wheels also can be arranged at a distance from the rotor end faces, wherein the fan wheels advantageously nevertheless are accommodated inside the winding heads, so that the fan wheels do not protrude beyond the end faces of the winding heads, so to speak. The interior of the winding heads is utilized for accommodating the fan wheels, whereby a short axial construction can be maintained.

To achieve an increased circulation of air, the fan also can include an additional fan motor, which advantageously is arranged on an outside of the end shield and drives a fan wheel independent of the rotor speed. In this case, the fan wheel driven by the fan motor advantageously is also seated on the outside of the end shield and hence no longer inside the winding head. In this configuration with separate fan motor, the cooling coils can also be seated outside the end shield in accordance with a development of the invention, wherein the cooling air is guided through corresponding recesses in the end shield, in order to ensure a circulation of air over the cooling coils. A bearing cap, which is seated on the end shield, can ensure a closed circulation of air. Alternatively or in addition, the end shield also can be formed correspondingly and accommodate said cooling air motor along with the radiator wheel and/or the cooling air coils.

The invention will subsequently be explained in detail with reference to preferred embodiments and associated drawings, in which:

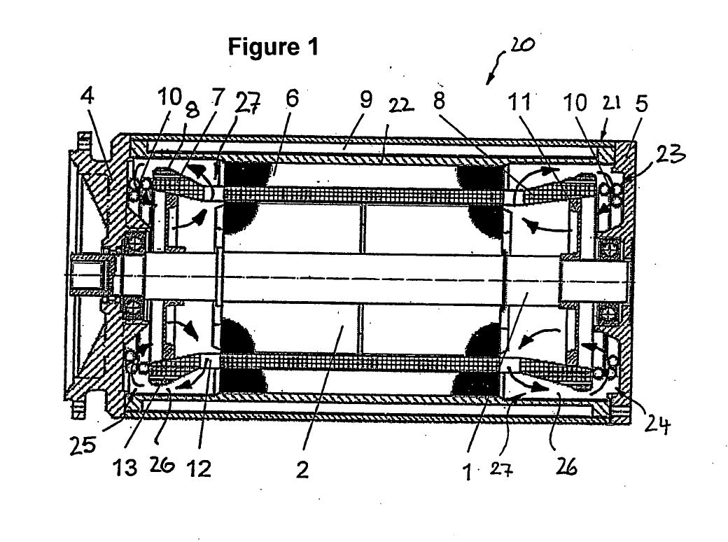

FIG. 1: shows a schematic longitudinal section through an electric machine with liquid and air cooling in accordance with an advantageous embodiment of the invention, in which the two winding head spaces are separated from each other and the cooling air is separately circulated in each winding head space in a closed circuit,

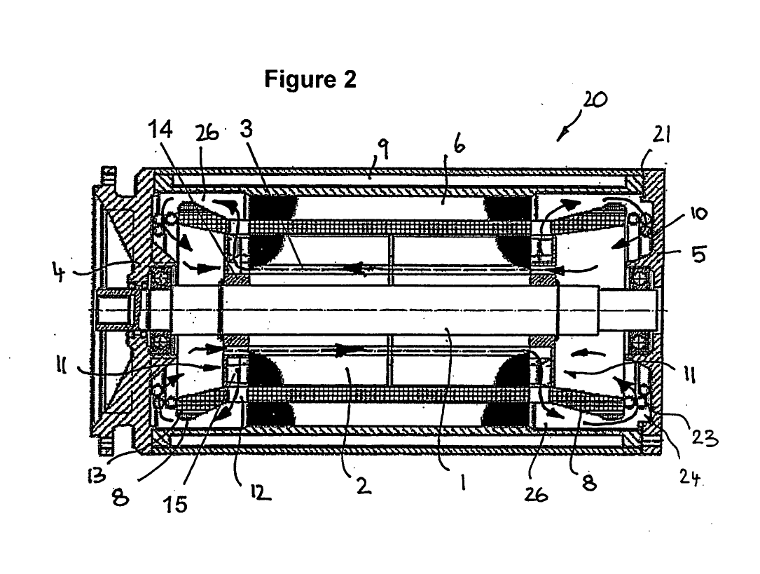

FIG. 2: shows a longitudinal section through an electric machine similar to FIG. 1 in accordance with a further advantageous embodiment of the invention, in which the cooling air is countercurrently guided through axial cooling air recesses in the rotor from the one winding head space to the other winding head space and back,

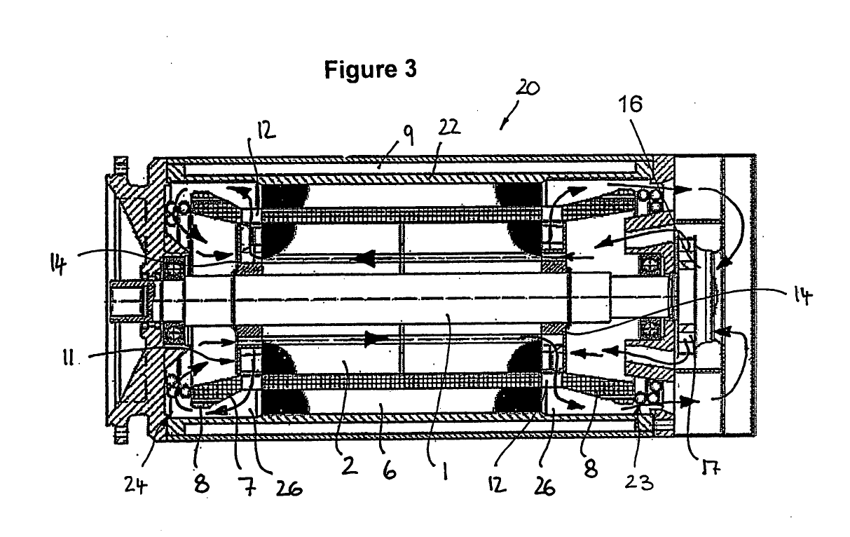

FIG. 3: shows a longitudinal section through an electric machine similar to FIG. 2 in accordance with a further advantageous embodiment of the invention, in which the fan includes a separate fan motor with fan wheel outside the end shield of the motor,

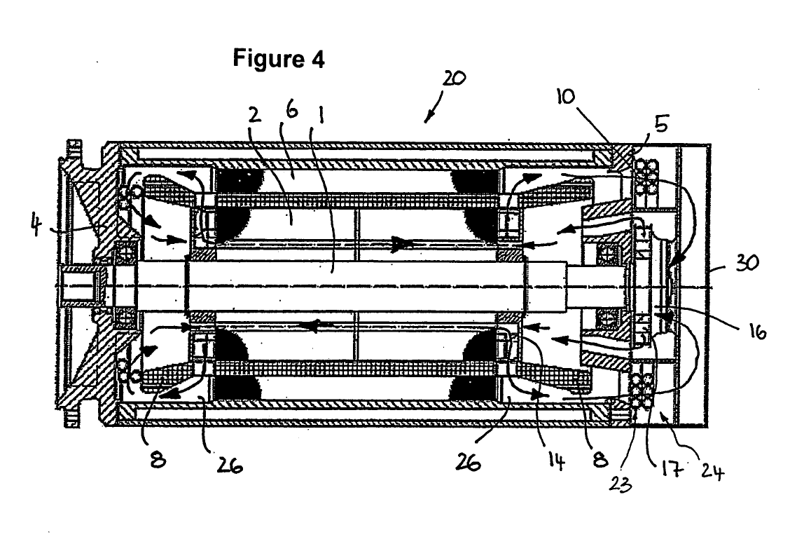

FIG. 4: shows a longitudinal section through an electric machine similar to FIG. 3, wherein the cooling air coils are arranged outside the end shield,

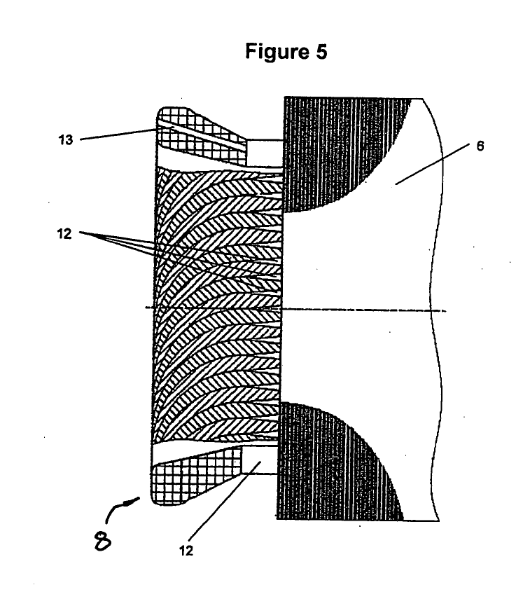

FIG. 5: shows an enlarged, cut-out view of the stator core and an adjoining winding head, which reveals the cooling air recesses in the winding head,

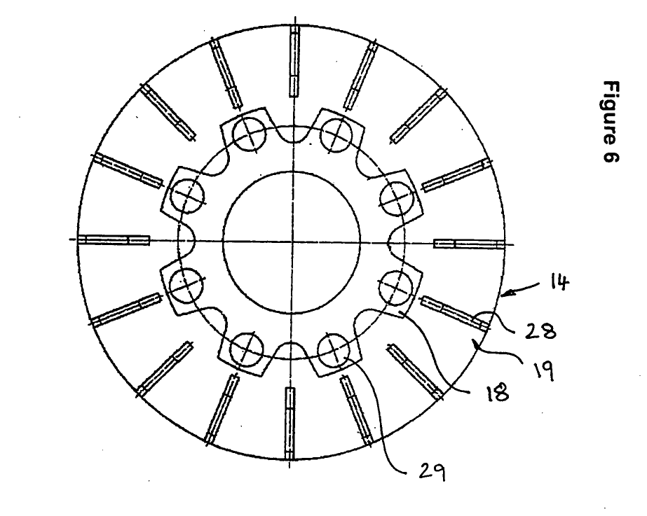

FIG. 6: shows a top view of a fan wheel constituting an attachment disk of the machine in accordance with the embodiments of FIGS. 2 to 4, and

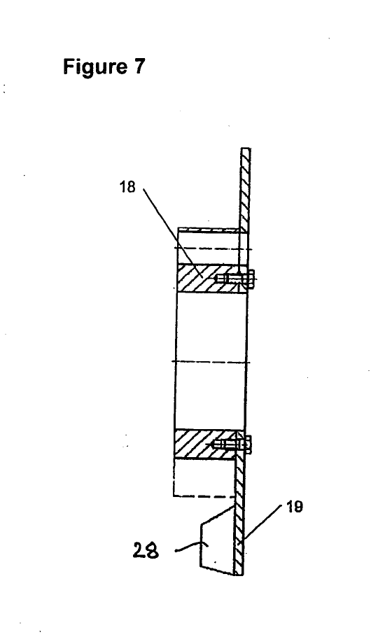

FIG. 7: shows an axial section through the fan wheel constituting an attachment disk of FIG. 6, which on the one hand reveals its blades and on the other hand its inlet passages for countercurrently passing the cooling air through the rotor.

The electric machine 20 shown in FIG. 1 comprises a shaft 1 with a rotor 2, which is rotatably mounted on end shields 4 and 5, which form part of a machine housing 21 and/or close a jacket 22 on its end face, which surrounds the stator 6 of the machine 20. Said jacket 22 includes a jacket cooling 9, through which cooling liquid of a liquid cooling circuit 23 is circulated. Said jacket is seated on the stator core without any clearance, level and/or flat, in order to achieve a good transfer of heat from the stator 6 into the cooling jacket.

Beside said liquid cooling circuit 23, the cooling device 24 of the electric machine 20 comprises an air cooling 25 for cooling the winding heads 8, which on both sides of the stator 6 and of the rotor 2 protrude into the winding head spaces 26 defined by the housing 21, to be more precise by the jacket 22 and the end shields 4 and 5. As shown in FIG. 1, the stator 6 comprises a winding 7, which is partly embedded in the stator core of the stator 6 and outside said stator core forms basket-like winding heads 8 from both sides.

To cool said winding heads 8, an internal circulation of cooling air is effected by means of fan wheels 11 in each of said winding head spaces 26, i.e. no ambient air is passed through the machine or guided over the winding heads 8, but an internal cooling air circuit is generated, which cools said winding heads 8. To withdraw heat from the cooling air, cooling coils 10 are provided in the winding head spaces 26, as shown in FIG. 1, through which cooling liquid is circulated. In principle, the liquid cooling circuit guided through said cooling coils 10 can be formed separate from the liquid cooling circuit 23 of the jacket cooling 22. Advantageously, however, coupling of the cooling coils 10 to the liquid cooling circuit 23 of the jacket cooling 22 can be provided, wherein depending on the thermal load of the individual machine components parallel coupling or also serial coupling of the cooling coils 10 to the jacket cooling 22 and to the liquid cooling circuit 23 feeding the same can be provided.

To achieve a strong cooling effect on the circulating cooling air, said cooling coils 10 advantageously are provided with a ribbing on their outside, for instance in the form of a plurality of axial ribs on each cooling tube, in order to increase the heat transfer surface of the cooling coils.

In the embodiment shown in FIG. 1, the cooling coils 10 substantially are seated on the end face of the winding heads 8 in a gap provided there between the end face of said winding heads 8 and the end shields 4 and 5, wherein said cooling coils 10 extend substantially annularly around the axis of the shaft 1.

In the embodiment as shown in FIG. 1, the fan wheels 11, which effect the circulation of air, are directly seated on said shaft 1 and are driven by the same. Advantageously, said fan wheels 11 are accommodated in the interior of the basket-like winding heads 8, wherein in the illustrated embodiment said fan wheels 11 are provided at a distance from the end faces of the rotor 2, cf. FIG. 1. In the illustrated embodiment, the fan wheels 11 are provided with axially acting blades, so that they axially force the air into the annular space, which is present around the shaft between the fan wheels 11 and the end faces of the rotor 2 and is defined from outside by the winding heads 8, cf. FIG. 1.

At their neck, i.e. in the region of transition to the stator core, the winding heads 8 are provided with radial through holes 12 which allow a passage of cooling air through the winding heads 8, as shown in FIGS. 1 and 5. Furthermore, longitudinally extending through holes 13 are provided in the winding heads 8, which on the one hand communicate with said radial through holes 12 and on the other hand open into the end face of the winding heads 8, so that cooling air can also be passed through the winding heads 8 in axial direction. As shown in FIG. 5, the longitudinally extending through holes 13 are smaller in cross-section than the aforementioned radial through holes 12 at the foot of the winding heads 8. For producing said through holes 12 and 13, suitable separating means for instance in the form of loops and tapes or also sleeves can be incorporated in the winding heads 8, in order to bundle or keep apart the coil strands.

Said through holes 12 form part of duct and guiding means 27, which effect an annular circulation of air around the basket-like winding heads 8, as is represented by the flow arrows in FIG. 1. At this point, the cooling air forced to the neck of the respective winding head 8 by the fan wheels 11 passes through said through holes 12 and 13, then is guided on the outside of the winding head 8 along the same to flow through between winding head 8 and jacket 22 to the end face of the respective winding head 8, and around this end face back to the inside of the winding head 8. On the end face of the winding head 8, the cooling air flows over the cooling coils 10, so that heat is withdrawn from the cooling air, which previously was dissipated by the winding of the winding head 8.

In principle, the configuration of the electric machine 20 shown in FIG. 2 is similar to the configuration shown in FIG. 1, so that the same reference numerals are used for the same components and in so far reference is made to the preceding description. The configuration of FIG. 2 substantially differs from that of FIG. 1 by the guidance of cooling air, in particular the air ducts 3 through the rotor 2 from the one winding head space 26 to the other winding head space on the opposite side and back, and by the formation of the fan wheels 11.

As shown in FIG. 2, the fan wheels 11 constitute attachment disks or press-on disks 14, which directly rest against the end face of the rotor 2 and are seated on the shaft 1. As shown in FIGS. 6 and 7, each attachment disk 14 comprises an inside disk member 18, which is seated on the shaft 1 and is seated on the end face of the rotor 2, and a fan member 19 connected with said disk member 18, which substantially consists of a radially protruding flange to which suitable air conveying means for instance in the form of conveying blades or vanes 28 are attached, cf. FIG. 7.

In said disk member 18, axial air ducts or air holes 29 are formed, which are distributed over the circumference and communicate with axial cooling air recesses or air ducts 3 in the rotor 2, which axially extend through said rotor 2 and each emerge from the end face of said rotor 2. In the rotor 2, twice as many air ducts 3 are provided as in the attachment disks 14, so that each of the attachment disks 14 with its air holes 29 only communicates with every second air duct 3 in the rotor 2. The two attachment disks 14 are rotatorily offset with respect to each other, so that a first set of air ducts 3 in the rotor 2 communicates with the interior of the winding head 8 via the air holes 29 in the attachment disk 14 on the left in FIG. 2, while a second set of air ducts 3 of the rotor 2 communicates with the interior of the winding head 8 on the right via the air holes 29 of the attachment disk 14 on the right in FIG. 2.

The air ducts 3 not opening into said air holes 29 in the disk member 18 each communicate, however, with the fan member 19 of the attachment disks 14, so that there is achieved the circulation of cooling air represented by the flow arrows in FIG. 2. This is accomplished as follows: The fan member 19 of the attachment disks 14, which operates radially and provides a radial exit of air towards the winding head 8, forces the cooling air through the through holes 12 provided at the neck of the winding heads 8 onto the outside of the winding heads 8. For this purpose, said attachment disks 14 are arranged in the vicinity of the neck of the respective winding head 8, wherein the protruding fan members 19 extend up to the inside of the winding heads 8 and rest against the same with a small air gap, cf. FIG. 2. The cooling air forced through the through holes 12 then circulates around the winding heads 8 similar to the guidance of air shown in FIG. 1, wherein it flows through between the respective winding head 8 and the jacket 22 on the outside, then around the end face of the winding head 8 and over the cooling coils 10, from where it reaches the inside of the winding head 8, cf. FIG. 2. From there, the cooling air is forced into the air holes 29 of the respective attachment disk 14, which in so far form inlet passages for the air ducts 3 of the rotor 2. The cooling air then flows through said cooling air ducts 3 through the rotor 2, in order to reach the fan member 19 of the attachment disk 14 provided there on the other side of the rotor. The cooling air then correspondingly circulates through and around the winding head 8 and then countercurrently back through the rotor 2, so that a countercurrent flow of cooling air through the aforementioned two sets of through holes 3 is generated in the rotor 2.

In principle, the electric machine shown in FIG. 3 has a similar construction as the machine shown in FIG. 2, with the difference substantially consisting in that the flow of the internal air flow is promoted by a fan motor 16, which is attached to the outside of the end shield 5 and forces the internal air flow after the cooling coil 10 on the right side in FIG. 3 into the air holes 3 of the rotor. Even at standstill, this construction allows an intensive cooling of the electric machine 20. As shown in FIG. 3, the fan motor 16 drives an additional fan wheel 17, which is seated on the fan motor 16, which in turn is seated on the outside of the end shield 5. Said end shield 5 includes cooling air inlet and outlet openings, so that the cooling air flow can be circulated over the outside of said end shield 5. On said outside of the end shield 5 a cup-shaped housing cap 30 is seated, through which a closed circuit of cooling air is provided.

FIG. 4 shows a further embodiment of the electric machine 20, which basically has the same construction as the embodiment of FIG. 3. In contrast thereto, the cooling coil 10 provided on the right is arranged on the outside of the end shield 5 in the embodiment of FIG. 4, where on the one hand more room is available for the cooling coil 10 and correspondingly a greater cooling coil 10 can be provided, and on the other hand a more efficient cooling of the cooling air can be achieved.

The electric machine 20 can be employed and used in a variety of ways. An advantageous application is the use as winch drive, wherein due to the highly efficient cooling with internal circulation of air the machine advantageously can be arranged inside the cable drum, without causing any thermal problems. The possible uses of the electric machine, however, are not restricted thereto.

1. An electric machine with a machine housing (21) in which a rotor (2) and a stator winding (7) are accommodated, wherein said stator winding (7) includes winding heads (8) arranged on opposite sides each in a winding head space (26), and with a cooling device (24) which includes a liquid cooling circuit (23) with a stator jacket cooling (9), cooling coils (10) and at least one air cooling (25), which preferably is connected with the rotor (2), for circulating air in the winding head spaces (26), characterized in that outside the winding head (8) the cooling coils (10) are guided through the winding head spaces (26) and the air cooling (25) includes two fan wheels (11) each associated to a winding head space (26) for generating an air flow circulating inside each winding head space (26), which by means of air duct and/or guiding means (27) in the respective winding space is guided so as to circulate over the exposed cooling coils (10) and through the winding heads (8).

2. The electric machine according to the preceding claim, wherein the air duct and/or guiding means (27) comprise preferably slot-shaped through holes (12) in the respective winding head (8), which are arranged at the neck of the winding heads (8) and are distributed over the circumference of the winding head (8).

3. The electric machine according to claim 2, wherein the air duct and/or guiding means (27) comprise cooling air recesses (13) extending through the winding heads (8) in longitudinal direction, which are connected with said through holes (12) at the neck of the winding heads (8).

4. The electric machine according to claim 1, wherein the air duct and/or guiding means (27) define a plurality of flow paths annularly extending around the winding heads (8), which each comprise said through holes (12), an outer portion between the respective winding head (8) and the machine housing (21), an end-face flow path portion between the winding head end faces and the end shields (4, 5) and an inner portion on the inside of the winding heads (8).

5. The electric machine according to claim 1, wherein the cooling coils (10) are arranged on the end faces of the winding heads (8).

6. The electric machine according to claim 1, wherein the cooling coils (10) include heat transfer ribs.

7. The electric machine according to claim 1, wherein the winding head spaces (26) each form closed air circulation spaces and are formed separate from each other in terms of cooling air circulation.

8. The electric machine according to claim 1, wherein the winding head spaces (26) form closed air circulation spaces and are connected with each other via air ducts (3) which extend through the rotor (2).

9. The electric machine according to the preceding claim, wherein the air duct and/or guiding means (27) include a counterflow means for countercurrently passing the cooling air through the rotor (2).

10. The electric machine according to claim 1, wherein the fan wheels (11) are formed by attachment disks (14) directly seated on the rotor (2) with fan members (17) and/or fan members (17) molded to the rotor (2).

11. The electric machine according to the preceding claim, wherein the attachment disks (14) are accommodated in the winding heads (8) and have radial discharge portions which open into the through holes (12) in the winding heads (8).

12. The electric machine according to claim 10, wherein the attachment disks (14) have air holes (29), which each are in flow connection with at least one air duct (3) in the rotor (2) and extend past the fan member (17) of the respective attachment disk (14), wherein the attachment disks (14) arranged on opposite end faces of the rotor (2) are rotatorily offset with respect to each other such that said air holes (29) of the one attachment disk (14) communicate with a first set of air ducts (3) of the rotor (2), and the air holes (29) of the other attachment disk (14) communicate with a second set of air ducts (3) of the rotor (2).

13. The electric machine according to claim 1, wherein the fan wheels (11) are arranged inside the winding heads (8) and are spaced from the rotor end faces.

14. The electric machine according to claim 1, wherein the fan (25) includes a fan unit preferably comprising a fan motor (16) and a fan wheel (17), which is arranged on an outside of the end shield and communicates with the winding head space (26) on the inside of the end shield.

15. The electric machine according to the preceding claim, wherein the cooling coils (10) on the machine side with said fan unit on the outside of the end shield are arranged on said outside of the end shield in a flow path from/to said fan unit.

16. A method for cooling an electric machine which includes a machine housing (21) in which a rotor (2) and a stator winding (7) are accommodated, which forms winding heads (8) arranged on opposite sides each in a winding head space, and cooling coils (10) connected to a liquid cooling circuit (23), wherein by means of air flow duct and/or guiding means (27) a cooling air flow circulatingly is passed through the winding head (8) in a first winding head space (26) and over the cooling coils (10), is then passed from said first winding head space (26) through a first set of axial air ducts (3) through the rotor (2) to the other rotor side into the second winding head space (26) provided there, in this second winding head space is passed through the winding head (8) and over further cooling coils (10), and finally is passed from the second winding head space (26) through a second set of axial air ducts (3) countercurrently with respect to said first set of air ducts through the rotor (2) back into the first winding head space (26).

17. Use of an electric machine according to claim 1 for driving a cable winch of hoisting devices such as cranes, cable excavators and similar construction machines, wherein the electric machine is arranged inside a cable drum of the cable winch.
